(19) United States
(12) Patent Application Publication
(10) Pub. No.: US 2010/0225953 A1
(43) Pub. Date: Sep. 9, 2010

(54) METHOD AND ASSEMBLY FOR RELEASING AND CONFIGURING SPECIFIC SYSTEM OPERATIONS OF A PRINTER OR PHOTOCOPIER

(76) Inventors: Ernst Engst, Unterschleissheim (DE); David Metz, Munchen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/293,638

(22) PCT Filed: Jan. 11, 2005
(86) PCT No.: PCT/EP07/50252

§ 371 Date: Sep. 19, 2008

(30) Foreign Application Priority Data
Mar. 20, 2006 (DE) 10 2006 012 677.7

(51) Int. Cl. G06F 15/00

(52) U.S. Cl. 358/1.15

(57) ABSTRACT

In a method or arrangement to select instructions to be executed by a control unit of a printer or copier, the control unit is connected with a plug connector arrangement providing an electrical connection to the control unit via a plurality of individual contact terminals. At least one first instruction stored in a first memory region is executed by the control unit in a first operating mode. At least one second instruction stored in a second memory region is executed by the control unit in a second operating mode. The second operating mode is set by at least one of the contact terminals of the plug connector arrangement, and wherein an evaluable signal level is respectively present at the at least one contact terminal. A memory region from which the at least one first instruction is loaded for execution by the control unit is established with aid of the electrical connection. An additional memory region from which the at least one second instruction is loaded for execution by the control unit is established in the absence of the electrical connection.

### BACKGROUND

The preferred embodiment concerns a method and an arrangement to select instructions to be executed by a control unit of a printer or copier. In a first operating mode, The control unit executes at least one first instruction stored in a first memory region and, in a second operating mode, executes at least one instruction stored in a second memory region.

Control units are known that, for clearing and configuration of specific system workflows and functions, take into account the settings of software switches (in particular via a user interface of a BIOS (basic input/output system) of the control unit), adjustable software switches or hardware switches that are arranged on a processor circuit board of the control unit. These hardware switches are in particular executed as DIP switches or jumpers. In order to activate a configuration or function, the corresponding switches on the circuit board must be repositioned, a jumper must be plugged in or pulled and a software switch must be set to the corresponding switch setting in the BIOS. The software switches have the disadvantage that their switch settings can often be changed by all operators, such that the functions and/or configurations to be set with the aid of these switches can be manipulated by any adept user.

The hardware switches (i.e. the DIP switches and the jumpers) arranged on the circuit board have the disadvantage that the circuit board must be freely accessible to change the switch setting. In particular, a module plugged into one module mount must be pulled from the module mount and the switch position of the respective switch must be changed. Given test functions, service functions and in production, the switch state would have to be changed a first time in order to provide the service, diagnosis, test or production function, and be changed a second time after implementing the respective function in order to reestablish the original switch state. However, thus is quite complicated, in particular for service assignments.

In the production process of the printer or copier, the control unit should be bootable from an external hard drive for testing and diagnosis purposes, which external hard drive is connected with the control unit via a standard interface (for example a USB interface). In the normal operating mode of the printer or copier, however, the booting from an external hard drive should not be possible and thus must be disabled. For the manufacturing process, in particular data of program elements with special test and diagnosis routines that should not be made available to service technicians and users are stored on the hard drive to be connected with the printer or copier. The alternative possibility of an exchange of the internal hard drive of the printer or copier or of another non-volatile memory of the printer or copier, respectively before and after the manufacturing process, is relatively complicated and contains additional sources of error.

A service technician should have write authorization to the hard drive or another non-volatile memory of the control unit for service purposes in order to be able to implement software updates, in particular updates, upgrades and patches as well as program extensions. However, accesses to these stores via external interfaces of the control unit should not be permitted in the normal operating mode.

In the event of a logical defect of a non-volatile memory (in particular a hard drive storage), an additional operating system (advantageously contained in the BIOS of the control unit) should be used to boot the control unit for reconstruction and/or installation of the data of the non-volatile memory at system start. This operating system is advantageously a minimal operating system that is required at least for reconstruction and installation of the memory. In the normal operating mode, only the operating system installed in the non-volatile memory (in particular that on the hard drive) should be capable of being used for booting.

In known control units, a module (in particular a motherboard of a control unit designed as computer system) contains switches and jumpers that adapt the configuration of the control unit to the respective requirements via different settings of the switches or jumpers, i.e. via different codings of the switches or jumpers. To activate a function, the switches or jumpers must be recoded, whereby an access to these switches is required. In order to ensure an access, the removal of casings and coverings, a disassembly and assembly of modules, the separation of plug connections and lines etc. are often required.

These techniques to achieve an access to the switches and jumpers lead to wear and to an elevated risk of damage to individual components or modules. However, intentional and unintentional manipulations via the activation of the protect functions are easily possible given freely accessible switches or jumpers, whereby the secure operation of the printer or copier can no longer be safely ensured. Visible switches also suggest hidden functions that can induce insufficiently trained users to alter their switch settings.

Malfunctions of and/or damage to the printer or copier cannot be precluded given an unintentional and/or unqualified change of these switch settings, such that the switches and jumpers should only be accessible to personnel trained for these.

A method and an arrangement for authentication of an operating unit of a printer or copier as well as the transfer of authentication information to the operating unit are known from the document WO 2004/039032 A2. With the aid of the authentication information, a control unit of the printer or copier determines the access rights of the operating unit so that, for example, accesses to the database and/or the control units of the respective printer are possible for a service technician given the use of a specially identified service notebook.

A diagnosis system for diagnosis of an automated teller machine is known from the document U.S. Pat. No. 6,953,150 B2, with which system the various components of the automated teller machine can be tested with the aid of text routines.

The aforementioned documents are herewith incorporated by reference into the present specification, wherein the methods, systems and techniques described there can be applied in connection with the present preferred embodiment.

### SUMMARY

It is an object to specify a method and an arrangement with whose help a selection of instructions to be executed by a control unit of a printer or copier is possible in a simple manner.

In a method or arrangement to select instructions to be executed by a control unit of a printer or copier, the control unit is connected with a plug connector arrangement providing an electrical connection to the control unit via a plurality of individual contact terminals. At least one first instruction stored in a first memory region is executed by the control unit in a first operating mode. At least one second instruction stored in a second memory region is executed by the control unit in a second operating mode. The second operating mode is set by at least one of the contact terminals of the plug connector arrangement, and wherein an evaluable signal level is respectively present at the at least one contact terminal. A memory region from which the at least one first instruction is loaded for execution by the control unit is established with aid of the electrical connection. An additional memory region from which the at least one second instruction is loaded for execution by the control unit is established in the absence of the electrical connection.

### BRIEF DESCRIPTION OF THE DRAWINGS

FIG. 1 is a block diagram for changing an address range of a ROM memory of a control unit with aid of an electrical connection established via a service dongle between the contact terminals of a plug connector arrangement of the control unit, according to a first embodiment of the invention;

FIG. 2 is a block diagram for changing an address range of a ROM memory of a control unit with aid of an electrical connection established via a service dongle between the contact terminals of a plug connector arrangement of the control unit, according to a second embodiment of the invention;

FIG. 3 is a block diagram for checking an electrical connection to set an operating mode, the electrical connection being established via a service dongle between the contact terminals of a plug connector arrangement of the control unit, according to a third embodiment of the invention;

FIG. 4a is an external view of the service dongle to establish an electrical connection with a plug connector arrangement of the control unit that is executed as a terminating plug and is exemplarily used in the first embodiment according to FIG. 1;

FIG. 4b is an external view of a service dongle that serves as an adapter plug between the plug connector arrangement of the control unit and a connecting plug of an apparatus, and that is exemplarily used in the second and embodiment according to FIGS. 2 and 3;

FIG. 4c is an external view of a service dongle 26 that possesses an external activatable switch to set the coding of the service dongle;

FIG. 5 is an overview of the contact connection pin assignment of an incompletely assigned 25-pin D-SUB plug connection according to the RS232 standard, with in particular ten free contact terminals;

FIG. 6 is an overview of the contact pin assignment of a fully assigned 25-pin D-SUB plug connector according to the RS232 standard, with three free contact terminals;

FIG. 7 is an overview of the contact pin assignment of a fully assigned 9-pin D-SUB plug connector according to the RS232 standard;

FIG. 8 is an overview of the contact pin assignment of a partially assigned 9-pin D-SUB plug connector according to the RS232 standard, with two free contact terminals;

FIG. 9 is an overview of the contact pin assignment of a partially assigned 9-pin D-SUB plug connector according to the RS232 standard, with six free contact terminals; and

FIG. 10 is an overview of the contact pin assignment of a partially assigned 25-pin D-SUB plug connector according to a parallel printer interface standard, with a modified contact pin assignment.

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

Via the method according to the invention and the arrangement according to the preferred embodiment it is achieved that an operating mode can be selected from at least two available operating modes in a simple manner, wherein a misuse or an unintentional activation of the second operating mode is avoided. For example, the control unit in the first operating mode can be operated with a first operating system with the aid of the at least one instruction stored in a first memory region, and in the second operating mode can be operated with a second operating system with the aid of the at least one instruction stored in a second memory region. Alternatively or additionally, with the aid of the instructions, first access rights and first operating and/or diagnosis functions can be provided to a user in the first operating mode and second access rights as well as second operating and/or diagnosis functions can be provided to a user in the second operating mode. The first access rights as well as operating and/or diagnosis functions in particular pertain to access rights or functions required for printer or copier operation. The second access rights as well as second operating and/or diagnosis functions in particular pertain to access rights and functions that are required for servicing and/or for configuration purposes in the manufacture or production of the printer or copier, and to set up as well as to test components of the printer or copier.

The electrical connection via the plug connector arrangement can be established with the aid of a plug connector arrangement designed complementary to the plug connector arrangement, which plug connector arrangement is advantageously designed in the manner of a dongle. This plug can in particular comprise a switch to establish and to separate the electrical connection. This switch can be freely accessible or be covered by a housing of the plug. Alternatively or additionally, a hard-wired connection can be provided to establish the electrical connection.

It is also advantageous when at least the second operating mode can additionally be selected via DIP switches or jumpers that are arranged on a circuit board of the control unit so that the second operating mode can also alternatively be set via these switches or jumpers, in particular in the production of the control unit or special tests in the production and/or development of the control unit and/or of the printer.

With the aid of the preferred embodiment, the operating mode is selected before the booting of the operating system so that the operating system is started and configured corresponding to the operating mode. For example, in the second operating mode booting can occur from a different data source, for example an external hard drive or a non-volatile memory (such as a USB stick, for example) that can be connected with the control unit via a standard interface.

The plug connection can, for example, be a plug connection arrangement of the control unit to provide a standard interface such as, for example: a V.24/RS232 interface with a D-SUB plug connector arrangement; or a USB interface with a USB plug connector arrangement; a SCSI interface with a SCSI plug connector arrangement; a parallel interface/Centronix interface with a D-SUB or Centronix plug connector arrangement; an Ethernet interface with an RJ-45 plug connector arrangement; a VGA interface with a mini D-SUB plug connector arrangement; a PS2 interface with a PS2 plug connector arrangement; a FireWire interface with a FireWire plug connector arrangement; as well as other plug connector arrangements typical in computers, data processing units, peripheral apparatuses and/or control units. Two contact terminals of these plug connector arrangements of these standard interfaces are advantageously used in order to establish the electrical connection of these free contact terminals. In particular, only one free contact terminal is required if a suitable operating voltage or a ground potential are already conducted via the plug connector arrangement of the standard interface, such that an electrical connection between the ground potential and the free contact terminal or between the suitable operating voltage and the free contact terminal can be established and an evaluable signal level is present at the contact terminal. This connection or this signal level is the used to select the second operating mode.

In particular, with the aid of the preferred embodiment it can be ensured in a simple manner that the common criteria are complied with, which common criteria establish (among other things) that functions and memory regions of the control unit may not be externally accessed, wherein such accesses should also be prohibited to a normal user who wishes to manipulate the control unit, albeit not maliciously. The secure operation of the printer or copier is thereby ensured. The update possibility of individual software components of the control unit can also be made dependent on the selection of a suitable operating mode.

Additional operating modes can be provided that are advantageously selected via additional electrical connections via the plug connector arrangement. In particular the service, manufacturing, production and quality assurance operating modes can be provided. In particular, a hard drive or another non-volatile memory of the control unit can be re-partitioned, formatted and written with new program data in the service operating mode. These program data can in particular comprise an operating system as well as application programs that are stored together as an image and are transferred from another data source or from another storage region of the hard disk to the hard disk or to the non-volatile memory of the control unit.

If the plug connector arrangement is directed outward, for example if it is accessible via the front bezel of a module of the control unit, the electrical connection to activate the second operating mode can be established without significant effort. In particular, no module must be opened or disassembled to set the second operating mode. In spite of this simple possibility to set the operating mode, misuse or an unintentional activation of the second operating mode without concrete knowledge of the electrical connection required for selection can be simply and effectively prevented, in contrast to freely accessibly arranged switches or jumpers or an inadvertent selection of the second operating mode. The control unit has a slight failure susceptibility due to this simple type of selection of the operating mode.

For a better understanding of the present invention, in the following the preferred exemplary embodiments presented in the drawings are referenced, which preferred exemplary embodiments are described using specific terminology. It is noted that the protective scope of the invention should not thereby be limited since such variations and additional modifications to the shown devices and/or the methods, as well as such additional applications of the invention as they are shown therein, are viewed as typical present or future expertise of a competent man skilled in the art. The drawing figures show exemplary embodiments of the invention.

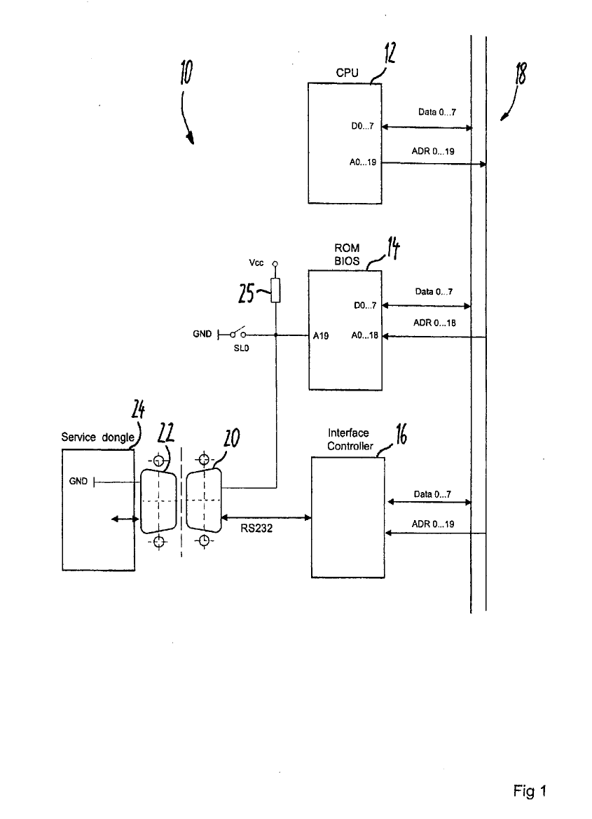

A block diagram for switching the operating mode of a control unit 10 according to a first embodiment of the invention is shown in FIG. 1. A central processing unit (CPU) 12, a non-volatile memory 14 and an interface controller 16 are respectively connected with a data bus 18. The memory 14 is advantageously a ROM, EEPROM and/or another non-volatile memory in which the program data and/or the configuration data of respectively at least one basic input/output system, a firmware, an operating system and/or an application program are stored in two memory regions differing from one another.

The interface controller 16 provides an interface functionality according to the RS232 standard at a plug connector arrangement 20. The plug connector arrangement 20 is a 9-pin D-SUB plug connector with projecting contact pins that is executed as a male plug connector. A plug connector 22 of a service dongle 24 that is designed to be complementary to the plug connector arrangement 20, this plug connector 22 being a 9-pin D-SUB plug connector with contact terminals designed as sockets. The plug connector 22 thus has female contact terminals.

In the state connected with the plug connector arrangement 20, the service dongle 24 generates an electrical connection between a ground potential (GND) that is provided by the RS232 interface and a free, unused contact of the plug connector arrangement 20 to provide the interface functionality of the RS232 interface. This contact terminal is connected with a supply voltage potential Vcc of, for example, 5 volts direct voltage via a pull-up resistor 25 and with an address line A19 to address the memory 14. A DIP switch SL0 via which a connection between the address line A19 of the memory 14 and the ground potential (GND) can be established parallel to the service dongle 24 is connected parallel to the electrical connection with the aid of the service dongle 24 between the ground potential (GND) and a free contact terminal.

If the switch SL0 is open, and if no service dongle 24 is connected with the plug connector arrangement 20, or if the switch SL0 is open and the service dongle 24 does not generate an electrical connection between the ground potential (GND) and the free contact terminal, the operating voltage potential VCC is present at the address line A19 of the memory 14, such that the address line A19 has a binary signal state “HIGH”. The binary signal state of the address line A19 can thus be set with the aid of the service dongle 24, whereby the address range of the memory 14 from which the CPU 12 reads data from the memory 14 via the data bus 18 is changed without additional techniques being necessary, and without another selection possibility being provided.

For example, to start a firmware and/or an operating system the CPU 12 reads instructions that are stored in the memory 14 beginning with the address 00000 (HEX=hexadecimal) if the service dongle 24 establishes the electrical connection between the ground potential (GND) and the free contact terminal and/or the DIP switches SL0 are closed. If the service dongle 24 does not generate an electrical connection between the ground potential (GND) and the free contact terminal, and if the DIP switch SL0 is open, a binary signal state “HIGH” is then present at the address line A19, whereby data from the memory range with the address 80000 (HEX)are read out by the CPU 12 upon readout of the address 00000 (HEX).

A switching of the address range of the memory 14 thus occurs in the control unit according to FIG. 1 with the aid of the service dongle 24 or, respectively, with the aid of the DIP switch SL0. Only the address range 00000 (HEX)to 7FFFF (HEX) of the memory 14 can thus be accessed via the interface controller 16 and the CPU 12. Given an electrical connection between the ground potential (GND) and the free contact terminal with the aid of the service dongle 24, the physical address range 00000 (HEX) to 7FFFF (HEX) is accessed. If no service dongle 24 is present and the DIP switch SL0 is not closed, the CPU12 and the interface controller alternatively access the memory range 80000 (HEX) through FFFFF (HEX), wherein the CPU 12 and the address controller 16 respectively use the address range 00000 (HEX) to 7FFFF(HEX) to address the memory 14. The data stored in the respective memory ranges can thus be used to operate the control unit 10. The actually used address range (i.e. the actually used memory range) of the memory 14 can thus be switched with the aid of the service dongle 24.

In particular, these data comprise settings and/or instructions of an operating system, pointers to memory ranges in which an operating system to be loaded is stored, and/or authorization settings to configure the access rights and implementable actions with the aid of the control unit 10. In the same manner, these data can comprise settings and/or instructions of a firmware of a basic input/output system (BIOS) and from application programs. By switching the memory range, a configuration of the control unit 10 can thus occur such that the control unit 10 is operated in a first operating mode with an open DIP switch SL0 and not with service dongle 24 connected with the interface arrangement 20 and in a second operating mode given a stretched service dongle 24 and/or given a closed DIP switch SL0.

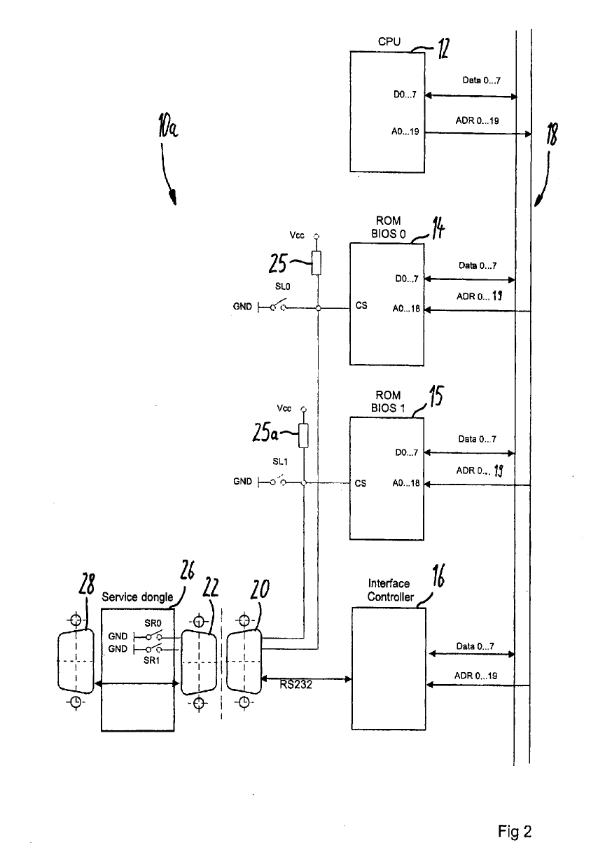

A block diagram with components of a control unit 10a of a printer or copier according to a second embodiment of the invention is shown in FIG. 2. The control unit 10a has a design similar to the control unit 10 according to FIG. 1. The same elements bear the same reference characters. In contrast to the control unit 10 of the first embodiment, the control unit 10a contains a second memory 15 in addition to the memory 14. In this second embodiment, data for operation of the control unit 10a in a first operating mode are stored in the memory 14 and data for operation of the control unit 10a in a second operating mode are stored in the memory 15.

In the exemplary embodiment according to FIG. 2, the memories 14 and 15 are different memory modules that are respectively activated with the aid of a control input CS. A service dongle 26 that is designed as an adapter plug and comprises two DIP switches SR0, SR1 is connected with the interface arrangement 20 of the control unit 10a. The control input CS of the memory 15 can be connected to ground with the aid of the DIP switch SR1 and the control input CS of the memory 14 can be connected to ground with the aid of the DIP switch SR2, whereby the signal state “Low” is present at these signal inputs given closed DIP switches SR0, SR1.

With regard to the DIP switches SR0 and SR1 of the service dongle 26, they are connected in parallel on a circuit board of the control unit 10a in the same manner as the DIP switches SL0, SL1 arranged in the exemplary embodiment according to FIG. 1. With the aid of the DIP switch SL1 that is connected parallel to the DIP switch SR1 of the service dongle 26, the signal input CS of the memory 15 can be connected in the same manner with ground potential (GND).

The service dongle 26 is thus executed as what is known as an adapter plug, wherein the service dongle 26 contains a second 9-pin D-SUB plug connector arrangement 28 to which the signals present at the plug connector arrangement 20 are directed to the RS232 interface. The plug connector arrangement 28 of the service dongle 26 is advantageously also executed in the same manner as the plug connector arrangement 20 with contact pins. The RS232 interface can thus be used in the same manner at the plug connector arrangement 28 as at the plug connector arrangement 20. For simplicity, the detailed representation of a chip select logic for the memory 14 (BIOS ROM) has been omitted.

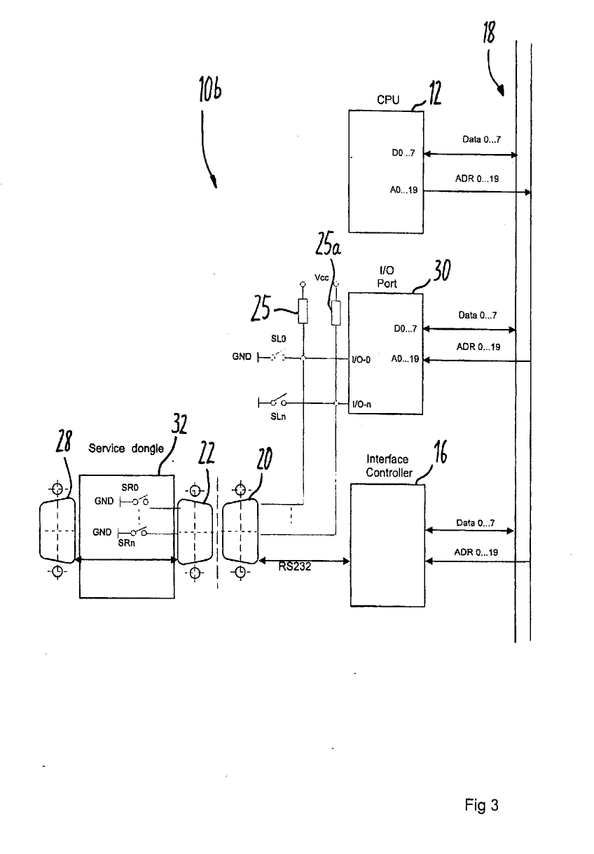

A block diagram of components of a control unit 10b of a printer or copier according to a third embodiment of the invention is shown in FIG. 3. In addition to the CPU 12, the interface controller 16, the data bus 18 and the plug connector arrangement 20, the control unit 10b has an input/output controller 30 that determines the switch states of DIP switches SR0 through SRn arranged in a service dongle 32 or of DIP switches SL0 through SLn connected in parallel with these DIP switches SR0 through SRn of the service dongle 32, which DIP switches SL0 through SLn are arranged on a circuit board of the control unit 10b. The control unit 10b is operated in a first operating mode or a second operating mode depending on these determined switch states. However, additional operating modes can also be provided. For example, a production operating mode, a service operating mode and a fabrication operating mode can be provided. Different fabrication modes, different printing modes and different service modes can also be provided, however.

In alternative control units, evaluation circuits or signal processing circuits are provided for evaluation of the switch states of the DIP switches SL0 through SLn arranged on the circuit board of the control unit and of the electrical connections generated by the service dongle 24, 26, 32, via which the operating mode selection generated by the respective service dongle 24, 26, 32 has priority independent of the switch states of the DIP switches SL0 through SLn. Alternatively, the DIP switches SL0 through SLn can also be arranged not directly on the circuit board of the control unit 10, 10a, 10b, but rather at another location. For simplicity, the detailed representation of a chip select logic for the memory 14 (BIOS ROM) has been omitted.

In the embodiment according to FIGS. 1 through 3, additional instructions that serve to initialize components of the control unit and/or evaluate the preset operating mode can be processed before the execution of the instructions according to the first operating mode and before the execution of the instructions according to the second operating mode.

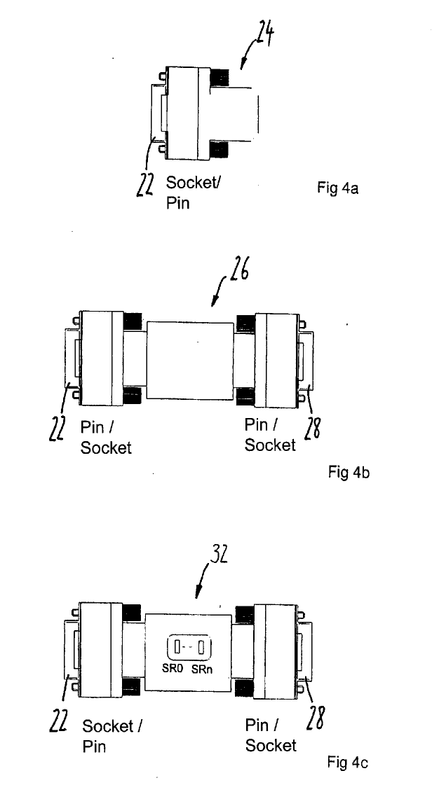

An external view of the service dongle 24 according to FIG. 1 is shown in FIG. 4a. This service dongle 24 is designed as a terminating plug and thus has neither a plug connector arrangement for connection of an additional apparatus to the RS232 interface nor a cable outlet for connection with an additional apparatus. Alternatively, the service dongle 24 can have a cable outlet via which a connection cable is directly connected with an additional plug or an additional plug connector arrangement or a peripheral apparatus is directly connected with the interface arrangement 20. The electrical connection can also be provided via a connection cable for a peripheral apparatus, in particular for a service notebook.

An external view of the service dongle 26 is shown in FIG. 4b. The service dongle has two plug connector arrangements, wherein the first plug connector arrangement 22 is designed complementary to the plug connector arrangement 20 of the control unit 10, 10a, 10b and is provided to connect with this plug connector arrangement 20. The second plug connector arrangement 28 is provided to supply the RS232 interface so that additional control units and peripheral apparatuses can be connected via the plug connector arrangement 28 with this RS232 interface in the same manner as with the interface arrangement 20. In this first embodiment of the service dongle 26 shown in FIG. 4b, the DIP switches SR0 and SR1 are arranged inside the service dongle 26. The switch positions of the DIP switches SR0 and SR1 of the service dongle 26 can thus only be changed by opening the housing of the service dongle 26. Alternatively, fixed jumpers can be provided in the service dongle 26 in order to establish the electrical connections between the ground potential (GND) and the free contact terminal used to select the operating mode.

An external view of the service dongle 32 is shown in FIG. 4c, in which—in contrast to the first embodiment of the service dongle 26 according to FIG. 4b—DIP switches SR0 through SRn accessible from outside the housing of the service dongle 32 are provided. The switch settings of the DIP switches SR0 through SRn can thereby be changed in a simple manner. Naturally, even given the service dongles 22, 26 according to FIGS. 4a, 4b, DIP switches can be provided that can be actuated from outside the housing of the service dongle 22. The provision of additional DIP switches is also possible in all mentioned embodiments. In particular, multiple dongles with different electrical connections can be provided in order to select different operating modes of a control unit.

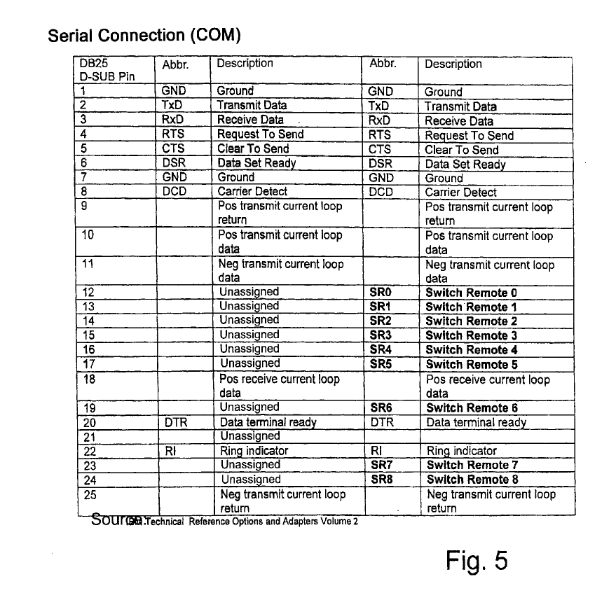

A table with an overview of the contact pin assignment of a 25-pin D-SUB plug connector according to the RS232 standard that, with in total, ten free contact pins is not fully assigned is shown in FIG. 5. The contact terminals 12 through 17, 19, 23 and 24 are not required for the interface function of the RS232 interface and thus can be used for setting the operating mode of the control unit 10, 10a, 10b, and thus to configure this control unit 10, 10a, 10b as described in connection with FIGS. 1 through 4. As is to be learned from the table shown in FIG. 5, contact terminal 12 can be connected with a contact pin of a switch SR0; the contact terminal 13 can be connected with a contact terminal of the switch SR1; the contact terminal 14 can be connected with a contact terminal of a switch SR2; the contact terminal 15 can be connected with a contact terminal of a switch SR3; the contact terminal 16 can be connected with a contact terminal of a switch SR4; the contact terminal 17 can be connected with a contact terminal of a switch SRS; the contact terminal 19 can be connected with a contact terminal of a switch SR6; the contact terminal 23 can be connected with a contact terminal of a switch SR7; the contact terminal 24 can be connected with a contact terminal of a switch SR8. The switches SRO through SR8 connect the respective contact terminal with the ground potential GND in the activated state.

The switches SR0 through SR8 are arranged in the service dongle 26 or 32 and are also designated as Remote. The switches SL0, SL1 arranged in the control unit 10, 10a, 10b (arranged parallel to the switches SR0 through SR8) are also designated as Local. The 25-pin D-SUB plug connector according to FIG. 5 is only partially assigned according to the RS232standard (in particular for modem operation), such that in total 10 contact terminals are not used, of which 9 are used to supply switch states from the switches SR0 through SR8. The respective other contact terminals of the switches SR0 through SR8 are respectively connected with the ground potential. Alternatively, these can be connected with another suitable potential or with an additional free contact terminal of the plug connector.

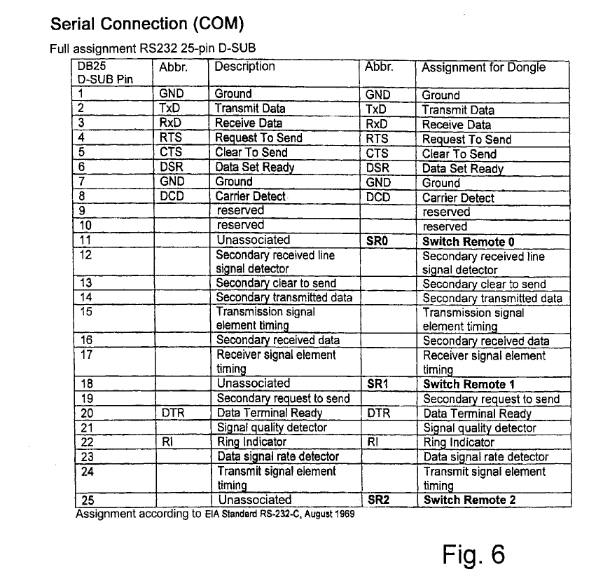

A table with an overview of the contact pin assignment of a fully assigned 25-pin D-SUB plug connector according to the RS232 standard with in total three free contact terminals is presented in FIG. 6. In contrast to the assignment shown in FIG. 5, in the fully assigned 25-pin D-SUB plug connector according to the RS232 standard only the contact terminals 11, 18 and 25 are unused and available for the transfer of the switching states according to the preferred embodiment from switches arranged in the service dongle 24, 26, 32 (or from electrical connections present in the service dongles 24, 26, 32). The contact terminal 11 of the 25-pin D-SUB plug connector is connected with a contact terminal of the switch SR0, the contact terminal 18 is connected with a contact terminal of the switch SR1 and the contact terminal 25 is connected with a contact terminal of the switch SR2.

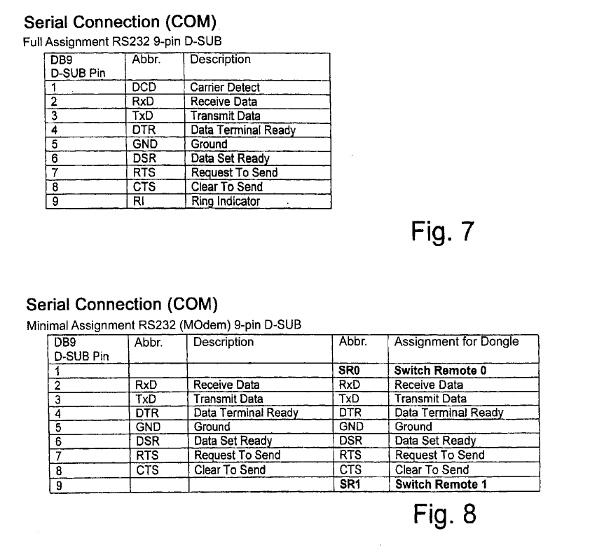

A table with an overview of the contact pin assignment of a fully assigned 9-pin D-SUB plug connector according to the RS232 standard without free contact terminals is presented in FIG. 7.

A table with an overview of the contact pin assignment of a 9-pin D-SUB plug connector according to the RS232 standard with a minimal assignment (in particular for modem operation) is shown in FIG. 8. Given this minimal assignment, a contact terminal of a switch SR0 can be connected with the contact terminal 1 of the 9-pin D-SUB plug connector and a contact terminal of a switch SR1 can be connected with the contact terminal 9 of the 9-pin D-SUB plug connector.

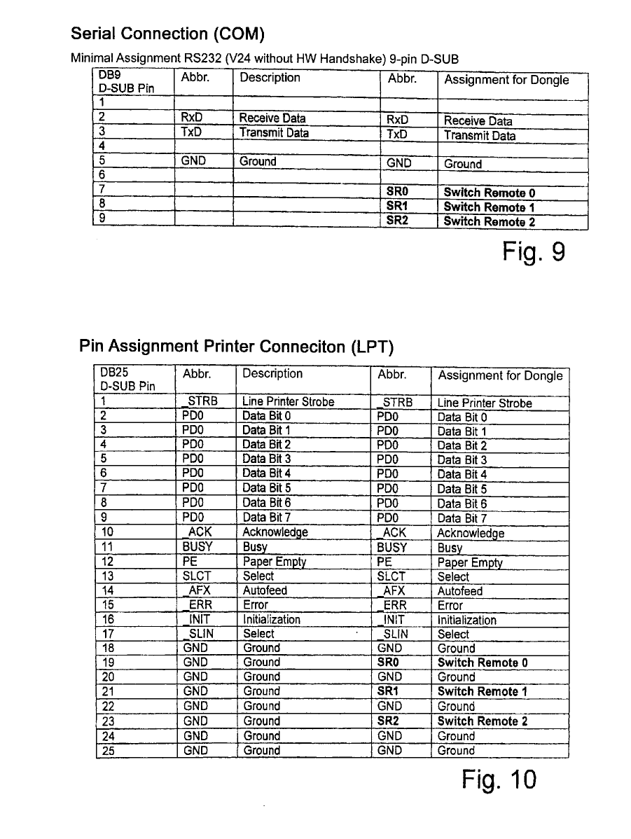

A table with an overview of the contact pin assignment of a 9-pin D-SUB plug connector according to the RS232 standard with an alternative minimal assignment of a 9-pin D-SUB plug connector according to the RS232 standard is shown in FIG. 9, in which no hardware exchange signals (what are known as handshake signals) are provided. Given this assignment of the 9-pin D-SUB plug connector, the contact terminals 1, 4, 6 through 9 of the plug connector are not assigned, such that these can be provided with contact terminals of switches for selection of an operating mode of a control unit 10, 10a, 10b. In the present exemplary embodiment, the contact terminal 7 of the 9-pin D-SUB plug connector is connected with a contact terminal of the switch SR0, the contact terminal 8 is connected with a contact terminal of the switch SR1 and the contact terminal 9 is connected with a contact terminal of SR2.

A table with an overview of the contact pin assignment of a 25-pin D-SUB plug connector of a parallel interface is shown in FIG. 10. This parallel interface is also designated as a printer connection or LPT. In the present exemplary embodiment, the contact terminals 19, 21 and 23 connected to ground according to the standard for the parallel interface are separate from ground and correspondingly connected with a contact terminal of the switches SR0, SR1 and SR2, such that these contact terminals 19, 21, 23 are connected with ground depending on the switch position of the switches SR0, SR1, SR2.

The preferred embodiment is not limited to D-SUB plug connectors and the shown assignments of these plug connectors. Rather, any plug connectors with free (i.e. unassigned) contact terminals can be used in order to generate an electrical connection that is used to set an operating mode or a control mode of the control unit 10, 10a, 10b. In particular, RJ-45 plug connector arrangements according to the Ethernet standard can be used in which not all present connection lines are used for data transmission, at least for 10 and 100 megabit transmission. Other plug connector arrangements such as mini-sub-D plug connector arrangements, DVI plug connector arrangements and additional plug connector arrangements (advantageously used to provide interfaces of the control unit 10, 10a, 10b) can also be used for the determination of the electrical connection of the service dongle 24, 26, 32 according to the preferred embodiment.

As already mentioned, the electrical connection to the plug connector arrangement 20 can occur with the aid of a jumper or a switch, wherein the electrical connection between two is established between two contact terminals not used to provide the interface, or between a potential of an operating voltage or of a signal level of the control unit (such as the voltage VCC or the ground GND). As an alternative to the jumper or to the switch, the electrical connection can also be established via an a (advantageously passive) component such as a resistor, a capacitor or an inductor, wherein an electrical property of this component advantageously produces the selection of the second operating mode. Such an electrical property can, for example, be the voltage drop across the component as well as the current and/or voltage curve upon closing and/or opening a circuit with this component.

With the aid of the present preferred embodiment, an additional or exclusive selection possibility of the operating mode via an electrical connection provided at a plug connector arrangement of a standard interface in addition to said standard interface is thus simple to select externally without the control unit itself or the circuit board of the control unit having to be accessible for the selection of the operating mode. Since the plug connector arrangements of the interfaces are typically accessible from outside the control unit, the selection of the operating mode according to the preferred embodiment is simply possible without great effort. In the exemplary embodiment, the electrical connection to select the operating mode has been produced with the aid of an arrangement designated as a service dongle, which has a plug connector arrangement complementary to the plug connector arrangement of the standard interface and can be connected in a simple manner with the plug connector arrangement 20 of the control unit.

In general, a copy protection plug is understood as a dongle. In the present preferred embodiment, the arrangement is connected with the plug connector arrangement of the control unit 10, 10a, 10b in the form of a plug. The plug can thereby have male and/or female contact terminals. In the preferred embodiment, any other type and configuration to establish the electrical connection between the free contact terminal of the plug connector arrangement and a suitable signal state potential (GND, VCC) of the control unit or between two contact terminals is thus suitable. The service dongle is thus not used as a copy protection plug in the conventional sense; rather, according to the preferred embodiment it serves to set a desired operating mode. Via the possible choice of the operating mode, in particular a boot order can be established via the selection of the memory range in which the data to be loaded and/or to be executed are stored.

The selection of the operating mode thus occurs via a coding of the switches SL0, SL1, SLn and, as an alternative to these switches, via the switches SR0, SR1, SRn of the service dongle, wherein the coding is generated via electrical connection established with the aid of these switches or with the aid of a jumper. Via the preferred embodiment, this coding possibility is displaced to a point easily accessible to the user, wherein free contact terminals are used by available plug connector arrangements of the interfaces of the control unit. Users can, for example, be normal operators, test engineers or service technicians. In spite of the easy accessibility of the plug connector arrangement 20 of the interface, the [sic] about the activatable function of the operating modes selection is not clear and also not easy to determine. The opening of the control unit or the extraction of modules from the module support of the control unit is no longer necessary due to the employed service dongle. In particular, the operating mode can also be changed during the operation of the control unit.

Via the preferred embodiment, the control unit can thus be adapted in a simple manner to different requirements for the production, for the assembly, for testing, for diagnosis, for system configuration and for updates and servicing of a printer or copier, in that an operating mode suitable for the respective application purpose is pre-set. It can thereby also be ensured that security criteria are complied with in normal printing operation. Different system workflows, functionalities and security criteria required for the normal printing operation and for service actions can also be taken into account.

For example, a control unit designed as a computer system can be bootable from an external hard drive for testing and diagnosis purposes. In normal operation mode, however, the booting from the external hard drive is not possible. The booting from the external hard drive can thus be permitted given the selection of a suitable operating mode via the electrical connection generated via the plug connector arrangement 20, and the booting from the external hard drive is not possible if this electrical connection is not present. In addition to or as an alternative to an operating system, the external hard drive can contain test routines for production of the printer or copier that should not be available to a service technician and users.

Another application possibility of the preferred embodiment is that the control unit 10, 10a, 10b has a hard drive storage which may be externally write-accessed (from outside the control unit) only during a service assignment in order in particular to install updates and to change settings. External write accesses to the hard drive storage are suppressed in the normal print operation mode of the control unit 10, 10a, 10b.

An additional application of the preferred embodiment can exist in that, in the case of a logical defect of a hard drive storage of the control unit 10, 10a, 10b (designed as a computer system), a minimal operating system stored on another storage region of the control unit 10, 10a, 10b can be booted at system start for reconstruction and installation of the hard drive. In particular, this minimal operating system enables a service technician to re-set up of the hard drive of the control unit. This minimal operating system can in particular be stored in the BIOS of the control unit 10, 10a, 10b. However, in the normal print operation mode the operating system installed on the hard drive should be booted.

According to the preferred embodiment, the signal state (i.e. the signal level) can be determined at an unused contact terminal of the standard interface with the aid of a BIOS function, and thus the presence of an electrical connection to the unused contact terminal can be determined at the standard interface. This interrogation is thus controlled by software. Alternatively, a memory range of a memory or of multiple memories can be switched to via hardware with the aid of the service dongle 24, 26, 32, as this has been explained by example in connection with FIG. 1. Another boot source can be selected or another presetting for booting can be used depending on the signal state or on the presence of the electrical connection at the plug connector arrangement 20 of the control unit 10, 10a, 10b.

Although a preferred exemplary embodiment has been shown and described in detail in the drawings in the preceding specification, it should be viewed as purely exemplary and not as limiting the invention. It is noted that only the preferred exemplary embodiment has been presented and described, and all variations and modifications that presently and in the future lie within the protective scope of the invention should be protected.

1-21. (canceled)

22. A method to select instructions to be executed by a control unit of a printer or copier, said control unit being connected with a plug connector arrangement providing an electrical connection to the control unit via a plurality of individual contact terminals, comprising the steps of:
executing at least one first instruction stored in a first memory region by the control unit in a first operating mode;
executing at least one second instruction stored in a second memory region by the control unit in a second operating mode;
setting the second operating mode by at least one of said contact terminals of said plug connector arrangement, and wherein an evaluable signal level is respectively present at the at least one contact terminal;
establishing a memory region from which the at least one first instruction is loaded for execution by the control unit with aid of the electrical connection; and
establishing an additional memory region from which the at least one second instruction is located for execution by the control unit in absence of the electrical connection.

23. A method according to claim 22 wherein after the activation or after the resetting of the control unit it is checked whether the electrical connection via the plug connector arrangement is present, the second operating mode being activated if the electrical connection is present, and the first operating mode being activated if the electrical connection is not present.

24. A method according to claim 22 wherein the connection between two contact terminals of the plug connector arrangement is established by connecting the plug connector arrangement with a complementary plug connector arrangement, and wherein the contact terminals of the plug connector arrangement and contract terminals of the complementary plug connector arrangement are designed as a plug/socket system.

25. A method according to claim 24 wherein the plug connector arrangement provides a standardized standard interface, wherein the plug connector arrangement as well as the complementary plug connector arrangement comprise a Sub-D plug connector, an RJ45 plug connector, a PS2 plug connector, a DVI plug connector, an RS232 plug connector or another standardized plug connector.

26. A method according to claim 25 wherein contact terminals of the plug connector arrangement that are not used to provide the standard interface are used to establish the electrical connection to set the second operating mode.

27. A method according to claim 22 wherein the second operating mode is set by a switching process that is generated by establishing an electrical connection between two contact terminals of the plug connector arrangement.

28. A method according to claim 22 wherein the plug connector arrangement is accessible from outside a module of the control unit or from outside the control unit.

29. A method according to claim 22 wherein the control unit is operated with aid of an operating system that is loaded after the activation of the control unit, wherein before the loading of the operating system it is checked with aid of a BIOS instruction whether the first operating mode, the second operating mode, or the third operating mode is selected.

30. A method according to claim 22 wherein an operating system stored in the first memory region is loaded and its instructions are respectively executed given the selection of the first operating mode, and an operating system stored in the second memory region is loaded and its instructions are respectively executed given the selection of the second operating module.

31. A method according to claim 22 wherein the plug connector arrangement is connected with a terminating plug or a pass-through plug, and wherein the electrical connection is established in the terminating plug or the pass-through plug.

32. A method according to claim 22 wherein an electrical connection between a ground potential and a supply voltage is established across a resistor in the state connected with the plug connector arrangement, such that an evaluable binary signal state is generated at the contract terminal.

33. An arrangement to select instructions to be executed by a control unit of a printer or copier, comprising:
a control unit that comprises access to a first memory region and access to at least one second memory region, wherein first instructions to be executed by the control unit in a first operating mode are stored in the first memory region, and wherein second instructions to be executed by the control unit in a second operating mode are stored in the second memory region;
a plug connector arrangement providing an electrical connection to the control unit via a plurality of individual contact terminals and via which the second operating mode is set with aid of at least one of said contact terminals and wherein an evaluable signal level is present at said at least one contract terminal; and
the electrical connection establishing a memory region from which the control unit loads the first instructions for execution, and in absence of the electrical connection the second memory region is established, from which the control unit loads the second instructions for execution.

34. An arrangement according to claim 33 wherein the plug connector arrangement is connected via a resistor with a ground potential and a supply voltage so that an evaluable binary signal state is generated at the contract terminal given an existing connection.

35. An arrangement according to claim 33 wherein
a connection between two contact terminals of the plug connector arrangement is established by connecting the plug connector arrangement with a complementary plug connector arrangement, the contact terminals of the plug connector arrangement and the contact terminals of the complementary plug connector arrangement being designed as a plug/socket system, and
the plug connector arrangement providing a standardized standard interface, the plug connector arrangement and the complementary plug connector arrangement comprising a Sub-D plug connector, an RJ45 plug connector, a PS2 plug connector, a DVI plug connector, an RS232 plug connector, or another standardized plug.
